(19) United States
(12) Patent Application Publication
(10) Pub. No.: US 2019/0205934 A1
(43) Pub. Date: Jul. 4, 2019

(54) ADVERTISING DEVICE AND METHOD THEREOF

(71) Applicant: HON HAI PRECISION INDUSTRY CO., LTD., New Taipei (TW)

(72) Inventor: JUNG-YI LIN, New Taipei (TW)

(21) Appl. No.: 15/981,997

(22) Filed: May 17, 2018

(30) Foreign Application Priority Data
Dec. 29, 2017 (CN) 201711489021.4

(51) Int. Cl. G06Q 30/02; H04L 12/58

(52) U.S. Cl. CPC G06Q 30/0256; H04L 51/046

(57) ABSTRACT

An advertising device obtains chat information during a chat session of a user, obtains keyword information from the chat information, searches for matching advertisements from a database according to the keyword information, and provides the matching advertisement when an interface of the chat session is changed to an interface allowing an advertisement when the matching advertisement has been obtained. When no matching advertisement has been obtained according to the keyword information, a preselected advertisement is provided.

### CROSS-REFERENCE TO RELATED APPLICATIONS

This application claims priority to Chinese Patent Application No. 201711489021.4 filed on Dec. 29, 2017, the contents of which are incorporated by reference herein.

### FIELD

The subject matter herein generally relates to advertising, and more particularly to an advertising device for providing advertisements according to needs of a user.

### BACKGROUND

Generally, advertisements are found in many places, but people who need them may not see them.

### BRIEF DESCRIPTION OF THE DRAWINGS

Implementations of the present disclosure will now be described, by way of example only, with reference to the attached figures.

FIG. 1 is a diagram of an embodiment of an advertising device in accordance with an embodiment of the present disclosure.

FIG. 2 is a diagram of the advertising device of FIG. 1 implemented in an electronic device.

FIG. 3 is a diagram of the advertising device of FIG. 1 implemented in an electronic device and a network advertising server.

FIG. 4 is a diagram of the advertising device of FIG. 1 implemented in a network advertising server in communication with an electronic device.

FIG. 5 is a function module diagram of the advertising device of FIG. 1.

FIG. 6 is flowchart of a method for advertising.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

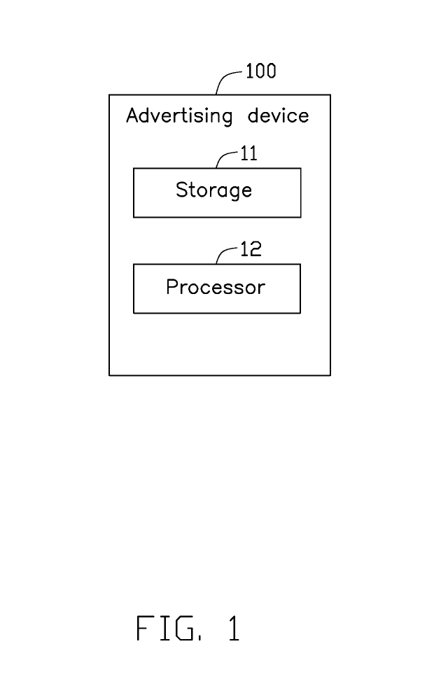

FIG. 1 illustrates an embodiment of an advertising device 100. The advertising device 100 obtains chat information from a chat session of a user, obtains keyword information from the chat information, obtains a matching advertisement according to the keyword information, and determines, when an interface is switched to an interface allowing advertisements, whether the keyword information matches any advertisements. If the advertising device 100 determines the keyword information matches any advertisements when the interface is changed to an interface allowing advertisements, then the advertising device 100 provides the matching advertisement on the interface. If the keyword information does not match any advertisements, then the advertising device 100 provides a preselected advertisement. The preselected advertisement is an advertisement having a highest priority in an advertisement database in communication with the advertising device 100. The interface allowing advertisements may be a search engine, a webpage, or the like set by a user.

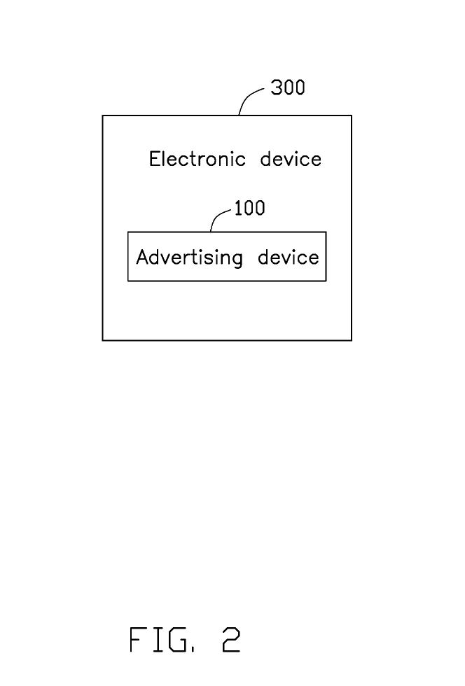

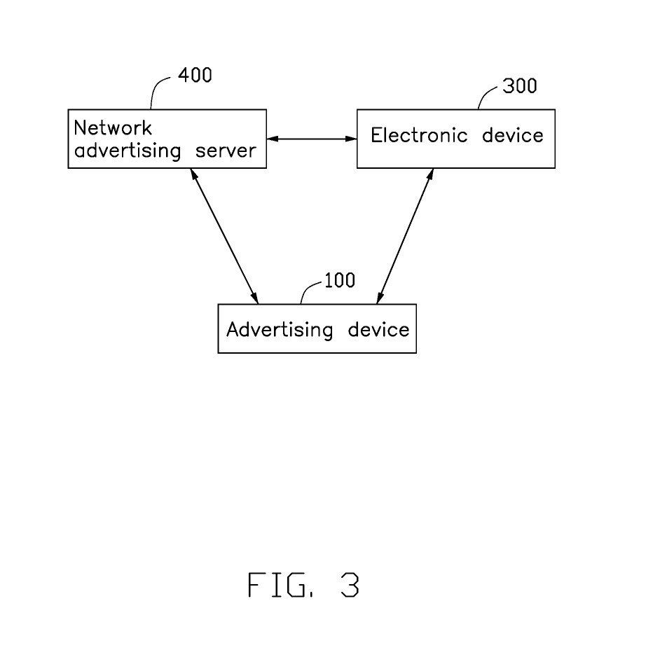

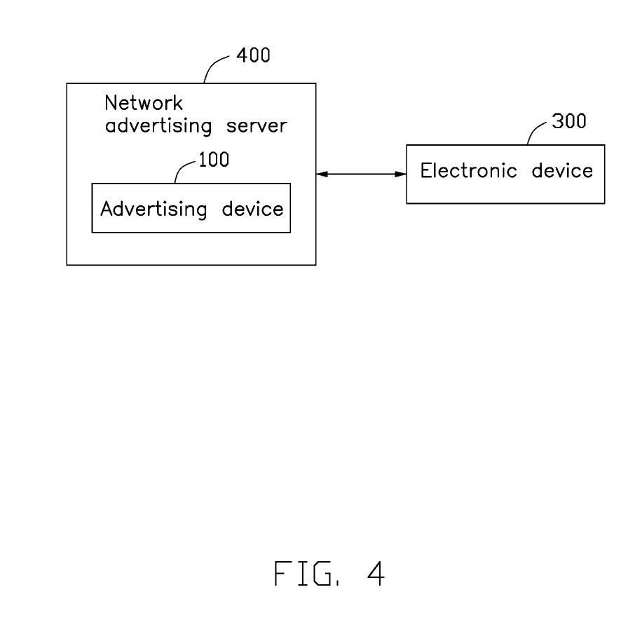

In a first embodiment, the advertising device 100 is installed in an electronic device 300, as shown in FIG. 2. The electronic device 300 may be a smart phone, a tablet computer, a desktop computer, or the like. In a second embodiment, a portion of the advertising device 100 is installed in the electronic device 300, and another portion of the advertising device 100 is installed in a network advertising server 400, as shown in FIG. 3. In a third embodiment, the advertising device 100 is installed in the network advertising server 400, such as a cloud server or a specialized advertising server, as shown in FIG. 4.

As shown in FIG. 1, the advertising device 100 includes at least one storage 11 and at least one processor 12.

The storage 11 stores data of the advertising device 100. The storage 11 can be an internal storage of the advertising device 100, or can be an internal storage of the electronic device 300/network advertising server 400 for implementing the advertising device 100. In at least one embodiment, the storage 11 can be a read-only memory, random access memory, or an external storage device such as a magnetic disk, a hard disk, a smart media card, a secure digital card, a flash card, or the like.

The processor 12 can be a processor of the advertising device 100, or can be a processor of the electronic device 300/network advertising server 400 for implementing the advertising device 100. The processor 12 can be a central processing unit, a microprocessing unit, or other data processing chip.

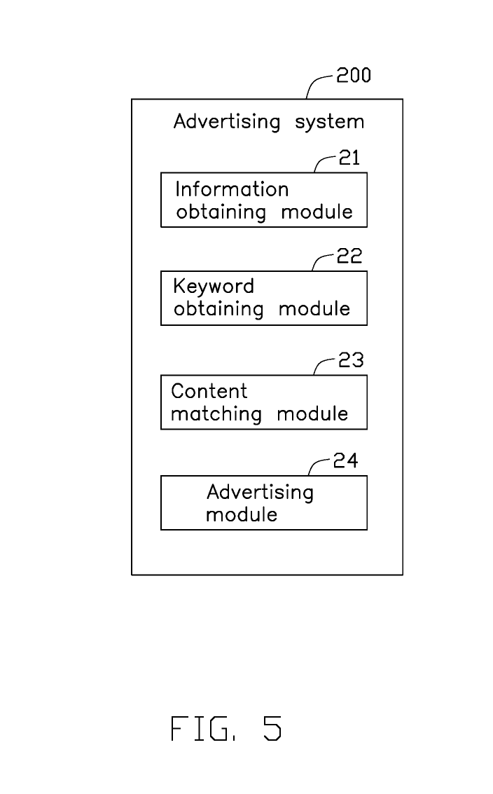

The advertising device 100 executes an advertising system 200, as shown in FIG. 5. The advertising system 200 can be divided into a plurality of modules, which can include one or more software programs in the form of computerized codes stored in the storage 11. The computerized codes can include instructions executed by the processor 12 to provide functions for the modules. The plurality of modules include an information obtaining module 21, a keyword obtaining module 22, a content matching module 23, and an advertising module 24.

In the first embodiment, the information obtaining module 21, the keyword obtaining module 22, the content matching module 23, and the advertising module 24 are implemented in the electronic device 300.

The information obtaining module 21 obtains the chat information from the chat session of the user. In the first embodiment, the information obtaining module 21 is installed in software of a chat program installed in the electronic device 300 or in a webpage providing the chat program displayed by the electronic device 300. The chat information may include text and/or voice information. The obtaining module 21 obtains the text information directly from the chat information, and converts the voice information into text information. The chat program may be, but is not limited to, QQ, MSN, or the like, or may be a webpage providing the chat program.

The keyword obtaining module 22 obtains the keyword information from the chat information. In detail, in the first embodiment, the storage 11 stores a database storing a plurality of groups of keywords. The keyword obtaining module 22 recognizes the keywords from the chat information by matching the keywords in the chat information to the keywords in the database. The keywords of the database are set by an administrator according to advertising needs. The keywords are linked to a corresponding advertisement of a product. For example, when flight company A wants to advertise a cheap flight to Japan, the keywords may be “Japan”, “flight tickets”, “discount tickets”, “discount tickets”, and “low price tickets”. When the user says, “I would like to go to Japan for travel”, the keyword obtaining module 22 checks that the keyword “Japan” matches the keyword “Japan” in the database, and obtains the keyword “Japan” from the chat information.

In the first embodiment, when the chat information includes a plurality of keywords, the keyword obtaining module 22 determines within a preselected time duration a frequency of the keywords appearing in the chat information. The keywords having a highest frequency have a highest priority.

The content matching module 23 searches the database for matching advertisements according to the keywords. In the first embodiment, the database is stored in the storage 11. The database stores a plurality of advertisements and a relationship between the plurality of advertisements and the keywords. The keywords correspond to the keywords stored in the database. As shown in FIG. 3, the advertisement corresponding to the keywords “Japan”, “flight tickets”, or “discount tickets” is an advertisement for discount tickets to Japan. In the first embodiment, the advertisements can be set by an administrator, or can be obtained from the network advertising server 400 in communication with a communication unit (not shown) of the electronic device 300. The advertisements may be refreshed at a preselected time period. The advertisements may be text, pictures, videos, animations, or a combination thereof.

In the first embodiment, when the content matching module 23 matches a plurality of advertisements to one keyword, the content matching module 23 matches the plurality of advertisements according to a priority of the advertisements. The priority of the advertisements may be set by an administrator. The priority may depend on how much money was paid for by an advertiser. For example, when the keyword “discount tickets” matches advertisements from flight company A and flight company B, and flight company B has a higher priority than flight company A, then the content matching module 23 provides the advertisement of flight company B before flight company A.

In the first embodiment, when the chat information includes a plurality of keywords, the content matching module 23 matches the keywords to the advertisements in order of appearance of the keywords.

The advertising module 24 provides the advertisements to the user. In detail, in the first embodiment, the advertising module 24 determines whether an interface has been switched to an interface allowing advertisements. For example, the interface allowing advertisements may be a search engine opened by the user or may be a webpage. If the interface has been switched to an interface allowing advertisements, the advertising module 24 determines whether a keyword matches any advertisements. When the keyword matches an advertisement, then the advertising module 24 provides the matching advertisement on the interface. When no keyword matches an advertisement, then the advertising module 24 provides a preselected advertisement. The preselected advertisement may be the advertisement in the database having the highest priority. The priority may be set by an administrator according to the amount paid for each advertisement.

In the first embodiment, when the keyword matches a plurality of advertisements, or when a plurality of keywords matches a plurality of advertisements, the advertising module 24 provides the plurality of advertisements according to the priority determined by the content matching module 23 and displays each advertisement in sequence according to a preselected time duration, such as 20 seconds.

In the first embodiment, the keyword obtaining module 22 obtains and refreshes the keywords in real time according to the chat information. The content matching module 23 matches the advertisements according to the refreshed keywords, and the advertising module 24 provides the matching advertisements. Thus, providing the advertisements special to the user's chat information is achieved.

In a second embodiment, the information obtaining module 21, the keyword obtaining module 22, and the advertising module 24 are implemented in the electronic device 300, and the content matching module 23 are implemented in the network advertising server 400.

The information obtaining module 21 obtains the chat information from the chat session of the user.

The keyword obtaining module 22 obtains the keyword information from the chat information. In detail, in the first embodiment, the storage 11 stores a database storing a plurality of groups of keywords. The keyword obtaining module 22 recognizes the keywords from the chat information by matching the keywords in the chat information to the keywords in the database. The database is the same as the database in the first embodiment.

They keyword obtaining module 22 further obtains input user information of the user of the chat session and sends the input user information and the keyword information to the network advertising server 400. In the second embodiment, the input user information may be, but is not limited to, an IP address of the user or other non-private information.

The content matching module 23 in the network advertising server 400 obtains the keyword information and searches for the matching advertisement in the database of the network advertising server 400 and sends the matching advertisement to the electronic device 300 according to the input user information. In the second embodiment, the advertisements in the database may be set by an administrator of the network advertising server 400.

The advertising module 24, upon receiving the matching advertisement from the content matching module 23, provides the advertisement to the user.

In a third embodiment, the advertising device 100, including the information obtaining module 21, the keyword obtaining module 22, the content matching module 23, and the advertising module 24, is implemented in the network advertising server 400, and the network advertising server 400 is in communication with at least one electronic device 300.

The information obtaining module 21 obtains the chat information and the input user information from the electronic device 300. The input user information may be the IP address of the user, for example. In the third embodiment, the electronic device 300 obtains the chat information from the chat session and sends the chat information and the input user information to the network advertising server 400.

The keyword obtaining module 22 obtains the keyword information from the chat information as in the first and second embodiments.

The content matching module 23 searches for the matching advertisement in the database of the network advertising server 400. In the third embodiment, the advertisements in the database may be set by an administrator of the network advertising server 400.

The advertising module 24 provides the advertisement to the user of the electronic device 300 according to the input user information.

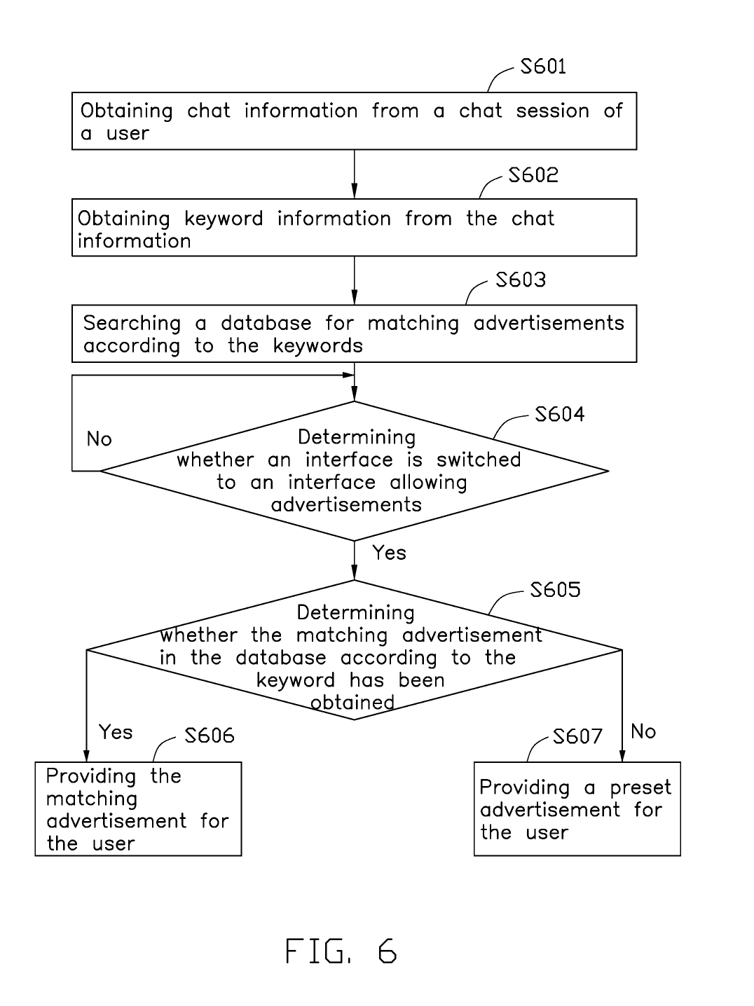

FIG. 6 illustrates a flowchart of a method for advertising. The example method is provided by way of example, as there are a variety of ways to carry out the method. The method described below can be carried out using the configurations illustrated in FIGS. 1-5, for example, and various elements of these figures are referenced in explaining the example method. Each block shown in FIG. 6 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block 601.

At block 601, chat information from a chat session of a user is obtained. The chat session can be in a chat program installed in an electronic device used by the user. The chat information can be text or audio. The audio is converted into text.

At block 602, keyword information is obtained from the chat information. In detail, the keyword information is recognized in a database storing a plurality of groups of keywords by matching the keywords in the chat information to the keywords in the database. The keywords of the database are set by an administrator according to advertising needs. The keywords are linked to a corresponding advertisement of a product.

At block 603, the database is searched for matching advertisements according to the keywords. The database stores a plurality of advertisements and a relationship between the plurality of advertisements and the keywords. The keywords correspond to the keywords stored in the database. The database can be stored in a network advertising server in communication with the electronic device.

At block 604, whether an interface is switched to an interface allowing advertisements is determined. When the interface has been switched to the interface allowing advertisements, block 605 is implemented. When the interface has not been switched, block 604 is repeated. In at least one embodiment, the interface allowing advertisements may be set by the user.

At block 605, whether the matching advertisement in the database according to the keyword has been obtained is determined. When the matching advertisement has been obtained, block 606 is implemented. When the matching advertisement has not been obtained, block 607 is implemented.

At block 606, the matching advertisement is provided for the user. In at least one embodiment, when the keyword information matches a plurality of advertisements, or when a plurality of keywords matches a plurality of advertisements, the plurality of advertisements are provided according to a priority of the advertisements and displayed in sequence according to a preselected time duration, such as 20 seconds.

At block 607, a preselected advertisement is provided for the user. In at least one embodiment, the preselected advertisement may be the advertisement in the database having the highest priority. The priority may be set by an administrator according to the amount paid for each advertisement.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for advertising comprising:
obtaining chat information during a chat session of a user;
obtaining keyword information from the chat information;
searching for matching advertisements from a database according to the keyword information;
determining, when an interface of the chat session is changed to an interface allowing an advertisement, whether the keyword information has been obtained and whether the keyword information matches an advertisement;
providing the matching advertisement when the matching advertisement has been determined; and
providing, when no matching advertisement has been determined according to the keyword information, a preselected advertisement.

2. The method of claim 1, wherein the preselected advertisement is an advertisement having a highest priority in the database; a priority of the advertisements is set by an administrator.

3. The method of claim 1, wherein the chat information is text or audio; when the chat information is audio, the audio is processed into text, and the text is obtained as the chat information.

4. The method of claim 1, wherein the keyword information is obtained by checking the database and automatically recognizing a matching keyword in the database according to the chat information; the database is set by an administrator; the database stores a plurality of groups of keywords; the keywords are associated with a product to be advertised.

5. The method of claim 4, wherein the database is stored in an electronic device of a user or in a network advertising server; the database stores a relationship between a plurality of advertisements and a plurality of keywords; the keywords correspond to the keywords stored in the database.

6. The method of claim 1, wherein when one keyword matches more than one advertisement or when the chat information contains a plurality of keywords matching a plurality of advertisements, the plurality of advertisements are provided in sequence, and each advertisement is displayed for a preselected time duration.

7. The method of claim 6, wherein the plurality of matching advertisements are ranked according to a preselected priority and are provided in sequence according to the preselected priority.

8. The method of claim 1 further comprising:
obtaining, after obtaining the keyword information, input user information;
sending the input user information and the keyword information to a network advertising server;
searching for matching advertisements in the database of the network advertising server; and
providing, according to the input user information, the matching advertisement.

9. An advertising device comprising:
a storage storing a plurality of instructions; and
a processor configured to execute the plurality of instructions that cause the processor to:
obtain chat information during a chat session of a user;
obtain keyword information from the chat information;
search for matching advertisements from a database according to the keyword information;
determine, when an interface of the chat session is changed to an interface allowing an advertisement, whether the keyword information has been obtained and whether the keyword information matches an advertisement;
provide the matching advertisement when the matching advertisement has been determined; and
provide, when no matching advertisement has been determined according to the keyword information, a preselected advertisement.

10. The advertising device of claim 9, wherein the preselected advertisement is an advertisement having a highest priority in the database; a priority of the advertisements is set by an administrator.

11. The advertising device of claim 9, wherein the chat information is text or audio; when the chat information is audio, the audio is processed into text, and the text is obtained as the chat information.

12. The advertising device of claim 9, wherein the keyword information is obtained by checking the database and automatically recognizing a matching keyword in the database according to the chat information; the database is set by an administrator; the database stores a plurality of groups of keywords; the keywords are associated with a product to be advertised.

13. The advertising device of claim 12, wherein the database is stored in the advertising device or in a network advertising server; the database stores a relationship between a plurality of advertisements and a plurality of keywords; the keywords correspond to the keywords stored in the database.

14. The advertising device of claim 9, wherein when one keyword matches more than one advertisement or when the chat information contains a plurality of keywords matching a plurality of advertisements, the plurality of advertisements are provided in sequence, and each advertisement is displayed for a preselected time duration.

15. The advertising device of claim 14, wherein the plurality of matching advertisements are ranked according to a preselected priority and are provided in sequence according to the preselected priority.

16. A non-transitory storage medium having stored thereon instructions that, when executed by at least one processor of a computing device, causes the at least one processor to execute instructions of a method for advertising on an advertising device, the method comprising:
obtaining chat information during a chat session of a user;
obtaining keyword information from the chat information;
searching for matching advertisements from a database according to the keyword information;
determining, when an interface of the chat session is changed to an interface allowing an advertisement, whether the keyword information has been obtained and whether the keyword information matches an advertisement;
providing the matching advertisement when the matching advertisement has been determined; and
providing, when no matching advertisement has been determined according to the keyword information, a preselected advertisement.
